(19) United States
(12) Patent Application Publication
(10) Pub. No.: US 2010/0241638 A1
(43) Pub. Date: Sep. 23, 2010

(54) SORTING CONTACTS

(76) Inventors: PATRICK JOSEPH O'SULLIVAN, Ballsbridge (IE); LIAM HARPUR, Skerries (IE); EDITH HELEN STERN, Yorktown Heights, NY (US); BARRY E. WILLNER, Briarcliff Manor, NY (US)

Correspondence Address: IBM CORPORATION, 3039 CORNWALLIS RD., DEPT. T81 / B503, PO BOX 12195, RESEARCH TRIANGLE PARK, NC, 27709, US

(21) Appl. No.: 12/406,495

(22) Filed: Mar. 18, 2009

(51) Int. Cl. G06F 7/06; G06F 17/30; G06F 15/16

(52) U.S. Cl. 707/752; 709/204; 707/E17.044

(57) ABSTRACT

A method, computer program product, and computing system for sorting contacts is provided. The method may include sorting a group of contacts within an address field of a message based upon, at least in part, a selected hierarchy. The method may also include displaying said group of contacts at a computing device according to said selected hierarchy. Of course, numerous other operations may be included without departing from the scope of this disclosure.

### TECHNICAL FIELD

This disclosure relates to a system and method for sorting contacts and, more particularly, to a system and method for sorting contacts according to a selected hierarchy.

### BACKGROUND

Today, email may be used as a general tool for broad collaboration. Email has led to an explosion of messaging in which many people communicate and share content. However, the mechanisms that we have to send, receive and process email do not lend themselves to successful collaboration in a broader context.

In corporate environments it is often the case that many different teams are involved in the production or completion of a product or other deliverable. Such teams may be linked together through an organizational structure where individual contributors report through managers and second line managers up to executives responsible for different aspects of the deliverable. For example, one team might be responsible for the initial design of a product, another team may be responsible for the implementation and yet a third one responsible for the marketing structure. Each of these teams may have an organization hierarchy, which may denote the particular level of each individual within the organization.

Currently, some messaging applications allow a user to send a message to a particular subset or group within the organization. Some of these applications may be configured to arrange the contacts in the address/invite field of the message alphabetically using an ordering process. What is needed is a way to make messaging, such as email more useful for broad collaboration, and to provide capabilities that can assist senders and recipients to meet the requirements imposed upon them in professional business and personal relationships.

### SUMMARY OF DISCLOSURE

In a first implementation, a computer-implemented method may include sorting a group of contacts within an address field of a message based upon, at least in part, a selected hierarchy. The method may further include displaying the group of contacts at a computing device according to the selected hierarchy.

One or more of the following features may be included. The message may be at least one of an email message and a calendar invitation. Further, the selected hierarchy may be based upon, at least in part, a social networking application and/or an organizational hierarchy. The message may be transmitted from the computing device and/or received at the computing device. The method may further include generating a multi-dimensional display of the selected hierarchy.

In a second implementation, a computer program product residing on a computer readable medium that may have a plurality of instructions stored on it is provided. When executed by a processor, the instructions may cause the processor to perform operations including sorting a group of contacts within an address field of a message based upon, at least in part, a selected hierarchy. Instructions may further include displaying the group of contacts at a computing device according to the selected hierarchy.

One or more of the following features may be included in the second implementation. The message may be at least one of an email message and a calendar invitation. Further, the selected hierarchy may be based upon, at least in part, a social networking application and/or an organizational hierarchy. The message may be transmitted from the computing device and/or received at the computing device. The method may further include generating a multi-dimensional display of the selected hierarchy.

In a third implementation a computing system is provided. The computing system may include a processor and a memory architecture coupled with the processor. The computing system may also include a first software module executed on the processor and the memory architecture, wherein the first software module is configured to determine a selected hierarchy. The computing system may further include a second software module configured to sort a group of contacts based upon, at least in part, the selected hierarchy.

One or more of the following features may be included. The selected hierarchy may be based upon, at least in part, at least one of a social networking application and an organizational hierarchy. The computing system may also include a third software module configured to receive a sorting request. In some embodiments, the selected hierarchy may be specified by at least one of a recipient and a sender of a message, the message including a sorted group of contacts. Additionally, the computing system may further include a fourth software module configured to transmit a message including a sorted group of contacts to a requesting computing device. The computing system may also include a fifth software module configured to communicate with at least one of a social networking application and an organizational hierarchy.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a sorting process and an email client application coupled to a distributed computing network;

FIG. 2 is a diagrammatic view of a display screen rendered by the sorting process and/or email client application of FIG. 1;

FIG. 3 is a diagrammatic view of a display screen rendered by the sorting process and/or email client application of FIG. 1; and

FIG. 4 is a flowchart depicting operations in accordance with the sorting process described herein.

Like reference symbols in the various drawings may indicate like elements.

### DETAILED DESCRIPTION OF THE PREFERRED EMBODIMENTS

### System Overview

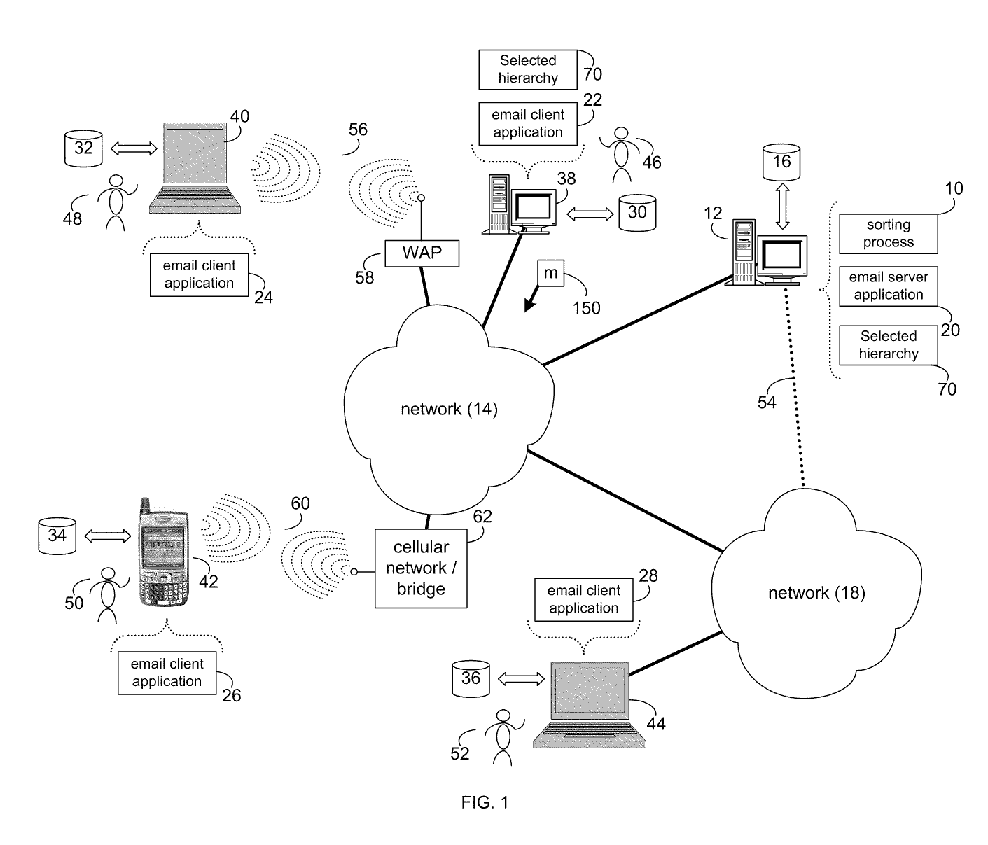

Referring to FIG. 1, there is shown sorting process 10 that may reside on and may be executed by server computer 12, which may be connected to network 14 (e.g., the Internet or a local area network). Although sorting process 10 is shown residing on server computer 12, it should be noted that this is merely one exemplary embodiment of the subject application. Accordingly, sorting process 10 may reside upon any or all of client devices 38, 40, 42, 44.

Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft Windows Server™; Novell Netware™; or Redhat Linux™, for example.

As will be discussed below in greater detail, sorting process 10 may include sorting a group of contacts within an address field of a message based upon, at least in part, a selected hierarchy. The method may further include displaying the group of contacts at a computing device according to the selected hierarchy.

The instruction sets and subroutines of sorting process 10, which may be stored on storage device 16 coupled to server computer 12, may be executed by one or more processors (not shown) and one or more memory architectures (not shown) incorporated into server computer 12. Storage device 16 may include, but is not limited to, a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include, but are not limited to, a local area network; a wide area network; or an intranet, for example.

Server computer 12 may execute email server application 20, examples of which may include, but are not limited to, Lotus Domino™ Server and Microsoft Exchange™ Server. Email server application 20 may be a mail transfer agent that may store and route email to one or more email client applications 22, 24, 26, 28, examples of which may include but are not limited to Lotus Notes™ and Microsoft Outlook™. Sorting process 10 may be a stand alone application that interfaces with email server application 20 or an applet/application that is executed within email server application 20.

The instruction sets and subroutines of email client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). In some embodiments, any or all of email client applications 22, 24, 26, and 28 may be a browser alone and/or may include code resident at the client device.

Storage devices 30, 32, 34, 36 may include, but are not limited to, hard disk drives, tape drives, optical drives, RAID arrays, random access memories (RAM), read-only memories (ROM), compact flash (CF) storage devices, secure digital (SD) storage devices, and memory stick storage devices. Examples of computing devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using email client applications 22, 24, 26, 28, users 46, 48, 50, 52 may access email server application 20 and may retrieve and/or organize email messages.

Users 46, 48, 50, 52 may access email server application 20 directly through the device on which the email client application (e.g., email client applications 22, 24, 26, 28) is executed, namely client electronic devices 38, 40, 42, 44, for example. Users 46, 48, 50, 52 may access email server application 20 directly through network 14 or through secondary network 18. Further, server computer 12 (i.e., the computer that executes email server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example.

Client electronic devices 38, 40, 42, 44 may each execute an operating system, examples of which may include but are not limited to Microsoft Windows™, Microsoft Windows CE™, Redhat Linux™, or a custom operating system.

### The Sorting Process:

This disclosure is directed towards a sorting process 10 configured to sort a group of contacts within an address field of a message based upon, at least in part, a selected hierarchy. Sorting process 10 may further include displaying the group of contacts at a computing device according to the selected hierarchy.

Sorting process 10 may be a server-side process, a client-side process, or a hybrid server-side/client-side process. Accordingly and for the following disclosure, sorting process 10 shall collectively refer to any and all combinations of server-side sorting process 10 and/or client-side sorting processes.

For example, server-side sorting process 10 may reside on and may be executed by server computer 12, which may be connected to network 14 (e.g., the Internet or a local area network). Examples of server computer 12 may include, but are not limited to, a personal computer, a server computer, a series of server computers, a mini computer, and a mainframe computer. Server computer 12 may be a web server (or a series of servers) running a network operating system, examples of which may include but are not limited to, any of the Microsoft Windows Server™ systems, Novell Netware™ systems, or Redhat Linux™ systems, for example.

For the following discussion, email client application 22 is going to be described for illustrative purposes. However, this is not intended to be a limitation of this disclosure, as other email client applications (e.g., email client applications 24, 26, 28) may be equally utilized.

Sorting process 10 may be configured to sort a group of contacts within an address field of a message. The contacts may be sorted based upon, at least in part, a selected hierarchy, which may include, but is not limited to, social networking, and/or organizational level hierarchies (e.g. as captured in lightweight directory access protocol “LDAP”). Sorting process 10 may further include displaying the group of contacts at a computing device according to the selected hierarchy. Although much of the discussion included herein is in the context of an email message, it should be noted that the term “message” as used herein, may refer to any type of digital message, including, but not limited to, email, calendar invitations, etc.

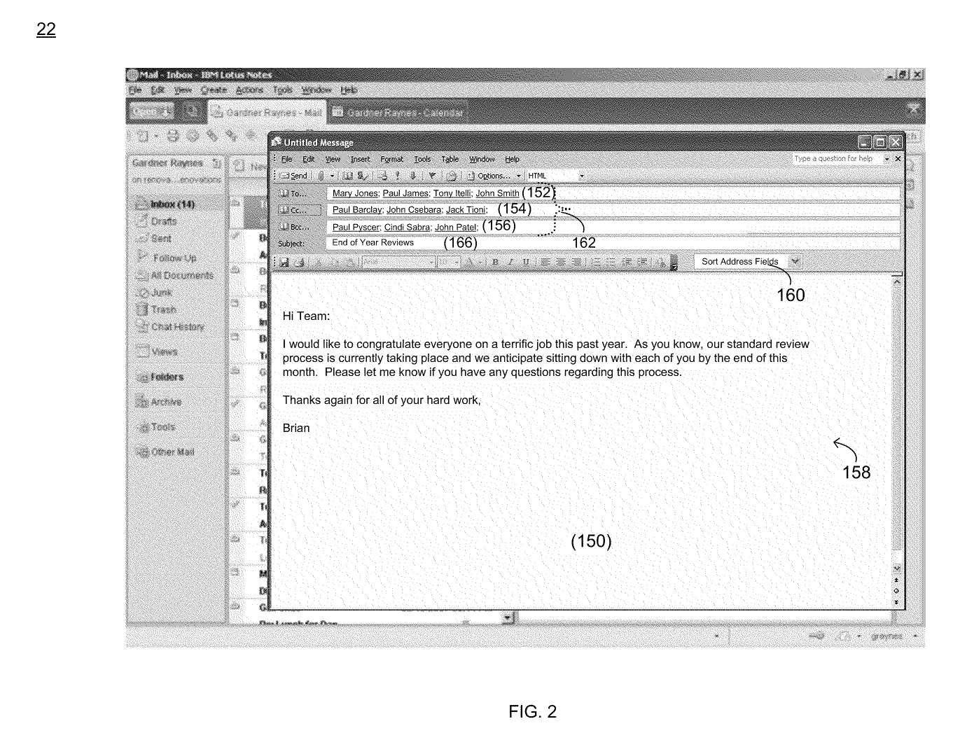

Referring also to FIG. 2, email client application 22 (alone or in combination with sorting process 10 and/or email server application 20) may allow a user (e.g., user 46) to generate email message 150 that is addressed to one or more recipients. Email message 150 may be addressed using various addressing fields, e.g., “TO” recipients 152, “CC” (i.e., carbon copy) recipients 154, and “BCC” (i.e., blind carbon copy) recipients 156. Further, email message 150 may include message content 158 (i.e., the body of the email message). Email message 150 may include a sorting selection tool 160, which when activated, may cause sorting process 10 to sort and/or organize a group of contacts 162 within any/or all of addressing fields 152, 154, and 156.

In some embodiments, sorting process 10 may be configured to sort group of contacts 162 in accordance with a selected hierarchy. The term “hierarchy” as used herein is intended to refer to the classification of a group of people according to ability or to economic, social and/or professional standing. For example, sorting process 10 may be configured to operate in accordance with an organizational hierarchy. The organizational hierarchy may include a corporate directory or similar feature that may map the reporting lines and organizational relationships between employees of a company. For example, in some embodiments, a lightweight directory access protocol (LDAP) or similar application protocol may be used to query and/or modify a hierarchical directory structure. In this way, sorting process 10 may communicate with LDAP to determine the order in which group of contacts 162 are displayed in address fields 152, 154, and 156. Sorting process 10 may also be configured to display the group of contacts at a computing device, e.g., computing device 38.

As shown in FIG. 1, selected hierarchy 70 may reside on any or all of client-side devices 38, 40, 42, 44, server 12, or both. Selected hierarchy 70 may be created using any number of suitable techniques. For example, in some embodiments selected hierarchy 70 may be set for all users of the messaging system (e.g., via policy, administrator selection, etc). Further, selected hierarchy 70 may be established by either the specific individual involved or alternatively by the organization itself. In this way, selected hierarchy 70 may be static or dynamic in nature and, as such, may be automatically or manually configured.

For example, user 46 may wish to transmit an email to his/her employees. Here, user 46 may utilize sorting process 10 to sort any or all of address fields 152, 154, and/or 156 so that the employees at the top and/or the bottom of the hierarchy are listed first in the address field.

In this way, user 46 may utilize sorting selection tool 160 to activate sorting process 10. The determination of importance and/or selected hierarchy may be made by user 46 and saved in his/her settings. Alternatively, the determination may be made automatically, for example, using the organizational hierarchy and/or LDAP described herein. Thus, if user 46 wanted to send a message to the officers and directors of his/her company, user 46 might want to sort the group of contacts according to an organization hierarchy. Here, upon the selection of the group “officers and directors” sorting process 10 may be configured to sort this group of contacts upon communicating with various sources, including but not limited to, an LDAP directory, the user's pre-set hierarchy, etc. For example, upon selecting “officers and directors” from sorting selection tool 160, sorting process 10 may sort and/or display the Chief Executive Officer (i.e. Mary Jones) first, Chief Financial Officer (i.e., Paul James) second, Vice President (i.e., Tony Itelli) third, Chairman of the Board (i.e., John Smith) fourth, etc. Additionally, user 46 may wish to include certain members of the group of contacts in CC field 154. Here, Directors (Paul Barclay, John Csebara, and Jack Tioni) may be included in CC field 154. Again, these settings may be user-configurable and/or determined with the assistance of an LDAP directory or using other suitable techniques.

Although, sorting selection tool 160 is shown in FIG. 2 as a drop-down menu, it should be noted that sorting process 10 may be activated using any suitable technique. For example, sorting process 10 may be activated using right-click activation, keystroke entry, button selection and/or alternative selection tools associated with email client application 22, etc.

In some embodiments, sorting process 10 may be configured to operate in accordance with a social networking system. The social networking system may be capable of mapping, for example, the user's 1^{st}, 2^{nd}, and 3^{rd} level of relationships between the users of the email network based on the frequency and nature of their interactions. Some exemplary social networking systems include, but are not limited to Facebook® and Linkedin®, which may utilize a gated access approach to connect different users through various levels of relationships. In any of the embodiments described herein, the user may specify where to obtain organizational and social networking information and/or graphical information (described in further detail below).

In this way, user 46 may wish to sort address fields 152, 154, and/or 156 based upon how close user 46 is with a particular individual or subject 166 of message 150. For example, if user 46 intends to transmit an email message to his/her family, he/she may wish for their husband or wife to be listed first, children second, other family members third, etc. Alternatively, user 46 may wish to transmit a message to his/her 1^{st} and 2^{nd} level contacts as set forth by various social networking systems. For example, an application such as Linkedin® may identify a user's various levels of contact, i.e., someone the user knows directly is a level 1, a friend of a friend may be a level 2, etc. In this way, sorting process 10 may be configured to sort group of contacts 162 within any or all of addressing fields 152, 154, and 156 according to these social hierarchies and/or as otherwise selected or set forth by user 46.

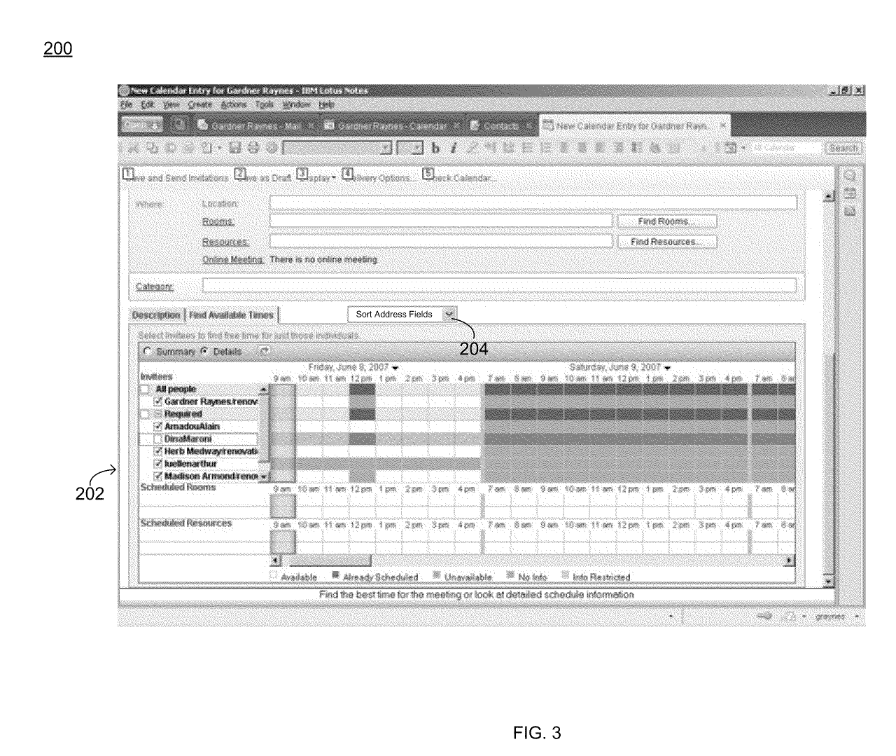

In some embodiments, sorting process 10 may be configured for operation with a number of different applications, and as such, is not limited to use with email messages, as calendar invitations and other messages are also envisioned. Referring now to FIG. 3, an additional embodiment of sorting process 10 is shown in the context of a calendar 200. As such, calendar 200 may include free-time window 202, which may be configured to display the availability of various contacts of a user, e.g., user 46. Calendar 200 may further include sorting selection tool 204, which may be similar to that described above with reference to FIG. 2.

In some embodiments, sorting process 10 along with email client application 22 may be configured to transmit a meeting invitation to a group of contacts. User 46 may consult calendar 200 to determine the best time to schedule the meeting. Further, user 46 may wish to sort the potential invitees in the meeting invitation and/or in free time window 202 so that the most important individuals are listed first in free-time window 202. Additionally, upon sending the email message, user 46 may wish to sort the contacts in the addressing field according to the organizational hierarchy. Alternatively and/or additionally, sorting process 10 may allow user 46 to sort the addressing field based upon the social networking applications described above. Numerous variations are possible without departing from the scope of the present disclosure. For example, the addressing field may be sorted based upon the recipient's relationship to the topic or the subject of the message. Sorting process 10 may also be configured to sort the addressing field so that the recipient always sees their name first, and/or so that the recipient's manager is second, etc. Similarly, the sorting may be initiated by an action of the receiving party rather than the sender.

In operation, a user may compose a message or meeting invitation using email client application 22. However, prior to sending the message or meeting invitation, the user (e.g., user 46) may be prompted if they want to sort the address field using different criteria, e.g., to sort an address field based on an organizational graph, social networking graph, the user's preselected order, etc.

As discussed above, sorting process 10 may operate as a client-side, server-side or hybrid client-server side process. The message may be transmitted from a computing device and/or received at the computing device, for example, computing device 38. Thus, in some embodiments, the receiver of the message may specify the sorting of contacts within the address fields rather than the sender. For example, user 46 may have had recent difficult negotiations with user 48's organization, and may want to ensure that they maintain a good relationship. As such, user 46 may want to sort incoming invitations and mail so as to see whether user 48's organization is included. Alternatively, a user, e.g., user 52, may have been told to get more exposure to senior management (or cross-group exposure) and would like to sort invites and mail so as to determine whether any given communication provides an opportunity to do so. Additionally, user 52 may want to ensure that his entire department is included in any message from senior management. Thus, user 52 may choose for sorting process 10 to list his/her particular department first in the addressing field for ease of review.

In some embodiments, sorting process 10 may further include generating a multi-dimensional display of the selected hierarchy. The sorted addressing may be in “To” field 152 on the e-mail so that it is seen by the recipients. Typically, this may be one or multiple lines and, as a result, may be an essentially linear display. However, during composition, the sender of the message, e.g., user 46, may wish to visualize the addressees in a two dimensional or higher dimensional graph. Sorting process 10 may be configured to display such a graph on the user's computing device, for example computing device 38. The address composition may be through the organizational graph or linear paradigm. Moreover, round tripping may be supported, i.e., the user may switch back and forth between composition or visualization in graph mode and composition and visualization in linear mode. In some embodiments, the graph may be explicitly sent and visualized by the recipient. Alternatively and/or additionally, a recipient may look at the graph of the addressees even if not formed by the sender. Sorting process 10 may also include composition and visualization of address groups within an address book.

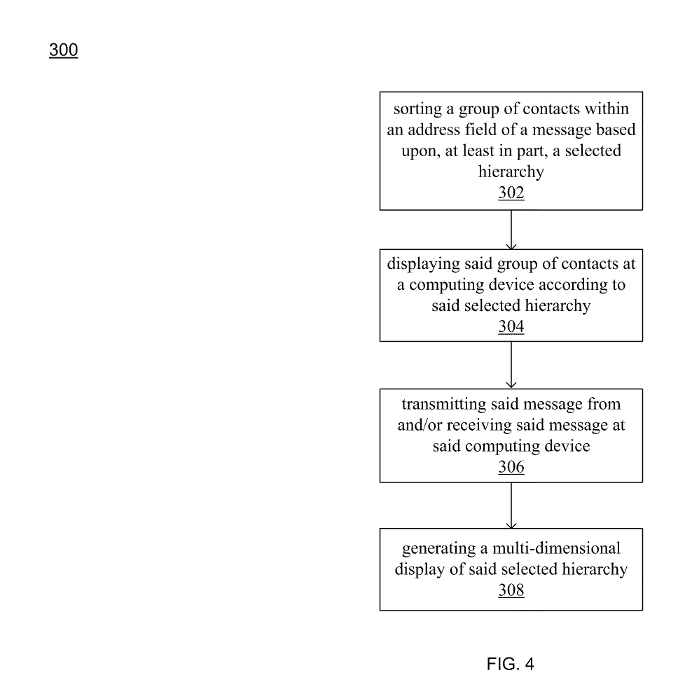

Referring now to FIG. 4, a method 300 depicting operations in accordance with sorting process 10 is provided. Operations may include sorting a group of contacts within an address field of a message based upon, at least in part, a selected hierarchy (302). Operations may also include displaying the group of contacts at a computing device according to the selected hierarchy (304). Operations may additionally include transmitting the message from and/or receiving the message at the computing device (306). Operations may further include generating a multi-dimensional display of said selected hierarchy (308). Numerous additional operations are also envisioned without departing from the scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A number of implementations have been described. Nevertheless, it will be understood that various modifications may be made. Accordingly, other implementations are within the scope of the following claims. For example, and as discussed above, although most of the discussion contained herein has focused upon email messages, this disclosure is not limited to these examples, as the sorting process described herein may be applied to calendar invitations and various other forms of messaging.

What is claimed is:

1. A computer-implemented method comprising:
sorting a group of contacts within an address field of a message based upon, at least in part, a selected hierarchy; and
displaying said group of contacts at a computing device according to said selected hierarchy.

2. The computer-implemented method of claim 1 wherein said message is at least one of an email message and a calendar invitation.

3. The computer-implemented method of claim 1 wherein said selected hierarchy is based upon, at least in part, at least one of a social networking application and an organizational hierarchy.

4. The computer-implemented method of claim 1 wherein the selected hierarchy is specified by a recipient of the message.

5. The computer-implemented method of claim 1 further comprising transmitting said message from said computing device.

6. The computer-implemented method of claim 1 further comprising receiving said message at said computing device.

7. The computer-implemented method of claim 1 further comprising generating a multi-dimensional display of said selected hierarchy.

8. A computer program product residing on a computer readable medium having a plurality of instructions stored thereon which, when executed by a processor, cause the processor to perform operations comprising:
sorting a group of contacts within an address field of a message based upon, at least in part, a selected hierarchy; and
displaying said group of contacts at a computing device according to said selected hierarchy.

9. The computer program product of claim 8 wherein said message is at least one of an email message and a calendar invitation.

10. The computer program product of claim 8 wherein said selected hierarchy is based upon, at least in part, at least one of a social networking application and an organizational hierarchy.

11. The computer program product of claim 8 wherein the selected hierarchy is specified by a recipient of the message.

12. The computer program product of claim 8 further comprising transmitting said message from said computing device.

13. The computer program product of claim 8 further comprising receiving said message at said computing device.

14. The computer program product of claim 8 further comprising generating a multi-dimensional display of said selected hierarchy.

15. A computing system comprising:
at least one processor;
at least one memory architecture coupled with the at least one processor;
a first software module executed on the at least one processor and the at least one memory architecture, wherein the first software module is configured to determine a selected hierarchy; and
a second software module configured to sort a group of contacts based upon, at least in part, the selected hierarchy.

16. The computing system of claim 15 wherein said selected hierarchy is based upon, at least in part, at least one of a social networking application and an organizational hierarchy.

17. The computing system of claim 15 further comprising a third software module configured to receive a sorting request.

18. The computing system of claim 15 wherein the selected hierarchy is specified by at least one of a recipient and a sender of a message, the message including a sorted group of contacts.

19. The computing system of claim 15 further comprising a fourth software module configured to transmit a message including a sorted group of contacts to a requesting computing device.

20. The computing system of claim 15 further comprising a fifth software module configured to communicate with at least one of a social networking application and an organizational hierarchy.
